(19) United States
(12) Patent Application Publication
(10) Pub. No.: US 2009/0158002 A1
(43) Pub. Date: Jun. 18, 2009

(54) NETWORK STORAGE DEVICE AND DATA READ-WRITE CONTROL METHOD

(75) Inventors: Yahong LIU, Shenzhen (CN); Hao YU, Shenzhen (CN); Jun XIAO, Shenzhen (CN); Liming WANG, Shenzhen (CN); Jiangang XIONG, Shenzhen (CN); Xin PANG, Shenzhen (CN); Guang HU, Shenzhen (CN); Chengge SHI, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/333,022

(22) Filed: Dec. 11, 2008

(30) Foreign Application Priority Data
Dec. 12, 2007 (CN) 200710032391.5

(51) Int. Cl. G06F 12/00

(52) U.S. Cl. 711/202; 711/E12.001

(57) ABSTRACT

An embodiment of the present invention discloses a network storage device including a physical storage medium. The network storage device further includes: a storage controller, configured to map the physical storage medium to sub-logical units and map the sub-logical units to logical units, so as to implement data storing, reading, and writing, wherein the sub-logical units are identified by sub-logical unit numbers and the logical units are identified by logical unit numbers. In addition, an embodiment of the present invention further discloses a data read-write control method. The present invention can enlarge valid storage capacity of the logical units, and is compatible with existing logical unit data read-write manners.

### CROSS-REFERENCE TO RELATED APPLICATIONS

This application claims priority to Chinese Patent Application No. 200710032391.5, filed Dec. 12, 2007, entitled “Network Storage Device and Data Read-Write Control Method,” the contents of which are hereby incorporated by reference in its entirety.

### FIELD OF THE INVENTION

The present invention relates to the field of network storage technology, particularly, to a network storage device and a data read-write control method.

### BACKGROUND

Network storage technology is a common network term based on data storage. Related technologies and protocols involved in network storage communication include Small Computer System Interface (SCSI), Redundant Array of Independent Disks (RAID), and optical fiber channel. RAID refers to a set of standards that provide improved performance and/or disk fault-tolerant capability. Generally, after RAID is implemented at a storage level, a raid group is divided into multiple logical units identified with logical unit numbers (LUN). Physical space of one logical unit may come from multiple disks. The logical unit numbers are located on an Operating System (OS) at an upper layer. The operating system maps a logical unit number to a disk. In the operating system, a stored and outputted logical unit number is mapped to a local disk.

In existing network storage systems, due to the limitations of addressing space and volume management software in operating systems of storage device and access host, the division of logical units is generally limited to a valid capacity of only 2TB. That is, in existing schemes, only big files less than 2TB can be read or written, and, thus, the division of 2TB logical units becomes a bottleneck. Furthermore, for a PB-level mass storage system, space management is complicated due to the limitation of 2TB logical unit division, which aggravates the workload of host-side management for storage space.

### SUMMARY

The technical problem to be solved by embodiments of the present invention is to provide a network storage device and a data read-write control method, so as to enlarge valid storage capacity of logical units and be compatible with existing logical unit data read-write manners.

A network storage device according to an embodiment of the present invention includes a physical storage medium, and further includes: a storage controller, configured to map the physical storage medium to sub-logical units and map the sub-logical units to logical units, so as to implement data storing, reading, and writing. The sub-logical units are identified by sub-logical unit numbers and the logical units are identified by logical unit numbers.

A data read-write control method according to an embodiment of the present invention includes: acquiring a mapping relationship between a physical storage medium and sub-logical units and a mapping relationship between the sub-logical units and logical units; and controlling data reading and writing, according to the mapping relationship between the physical storage medium and the sub-logical units, and the mapping relationship between the sub-logical units and the logical units.

### BRIEF DESCRIPTION OF THE DRAWINGS

FIG. 1 is a schematic structure diagram of a network storage device, according to an embodiment of the present invention;

FIG. 2 is a schematic structure diagram of a storage controller, according to an embodiment of the present invention;

FIG. 3 is a flowchart for a data read-write control method, according to an embodiment of the present invention; and

FIG. 4 is a schematic diagram illustrating an embodiment for implementing reliable read-write, according to the present invention.

### DETAILED DESCRIPTION

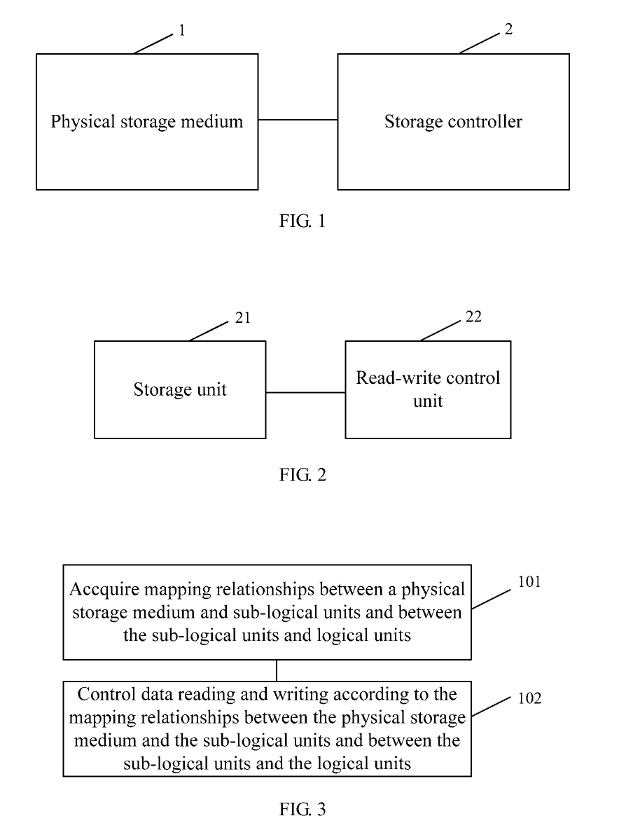

Referring to FIG. 1, it is a schematic structure diagram of a network storage device, according to an embodiment of the present invention.

The network storage device in the present embodiment includes: a physical storage medium 1, mainly configured to implement actual data storing; and a storage controller 2, mainly configured to map the physical storage medium 1 to sub-logical units and map the sub-logical units to logical units, so as to implement data storing, reading and writing, wherein the sub-logical units are identified with sub-logical unit numbers and the logical units are identified with logical unit numbers.

Referring to FIG. 2, it is a schematic structure diagram of an embodiment of the storage controller.

The storage controller 2 in the present embodiment may include a storage unit 21 and a read-write control unit 22.

The storage unit 21 is configured to store a mapping relationship between the sub-logical units and the physical storage medium 1 and a mapping relationship between the sub-logical units and the logical units. In a specific implementation, for example, a mapping relationship of linked list or other data structure may be employed for the mapping relationship between the sub-logical units and the physical storage medium, and a mapping relationship of one-to-one mapping or other one-to-one correspondence may be employed for the mapping relationship between the sub-logical units and the logical units.

The read-write control unit 22 is configured to control data storing, reading, and writing, according to the mapping relationship between the sub-logical units and the physical storage medium, and the mapping relationship between the sub-logical units and the logical units. For example, the read-write control unit 22 may implement data storing, reading, and writing in a reliable read-write manner, control data reading and writing in the sub-logical units, according to a preset order, and implement data reading and writing, according to the start position identification of data blocks stored in each of the sub-logical units, so as to properly manage and utilize space of the physical storage medium and perform an effective file storing, reading, and writing.

Referring to FIG. 3, it is a flowchart for a data read-write control method, according to an embodiment of the present invention.

The data read-write control method in the present embodiment mainly includes the following steps.

In block 101, a mapping relationship between a physical storage medium and sub-logical units and a mapping relationship between the sub-logical units and logical units are acquired. As described above, a mapping relationship of linked list or other data structure may be employed for the mapping relationship between the sub-logical units and the physical storage medium, and a mapping relationship of one-to-one mapping or other one-to-one correspondence may be employed for the mapping relationship between the sub-logical units and the logical units.

In block 102, data reading and writing is controlled, according to the mapping relationship between the physical storage medium and the sub-logical units, and the mapping relationship between the sub-logical units and the logical units. In a specific implementation, for example, data reading and writing may be implemented in a reliable read-write manner, data reading and writing in the logical units is controlled, according to a preset order, and data reading and writing may be implemented, according to the start position identification of data blocks stored in each of the sub-logical units, so as to properly manage and utilize space of the physical storage medium, and perform an effective file storing, reading, and writing.

In the above-mentioned embodiments, the sub-logical units are introduced on the basis of logical unit virtualization policy for implementing division, management, and aggregation sub-logical unit based of the logical units, which allows logical unit division of more than 1PB of valid host access space, and achieves mass storage. For example, the sub-logical units use 2TB level as their storage unit while the logical units may use up to 1PB level as their storage unit. Because the storage controller of the storage device performs virtualization operation of underlying logical units, and mapping and aggregating of the sub-logical units to the logical units are independent of the host, the host may implement reliable data read-write access in a manner completely compatible with existing access mechanisms.

It should be noted that in the present embodiment, the physical storage medium such as a memory may implement traversal between physical storage space and the sub-logical units via a mapping linked list, without repetition and miss of mapping. The entire mapping relationship is linked via index data structure of the sub-logical units, and access entries for the logical units are then formed through the aggregation of one-to-one mapping between the sub-logical units and the logical units. For data read-write requests originated from the host, the storage controller of the storage device performs reliable read-write operation to implement normal access to storage space covered by the logical units.

For example, the host system of a storage disk array uses logical unit port numbers for redirection, establishes redirection list of the logical units in the memory of the storage controller of the array, and adds logical unit extension byte to logical unit identifiers. For example, this byte may be a 64-bit binary symbol with low 32 bits being used and high 32 bits being reserved.

In the entire storage space layout, aggregation mapping of logical units in existing storage space may be employed, and the space of each sub-logical unit may be identified by a logical unit extension byte. The smallest unit of each sub-logical unit is 2TB. Thus, a high-speed and efficient 1PB space access to the logical units may be supported.

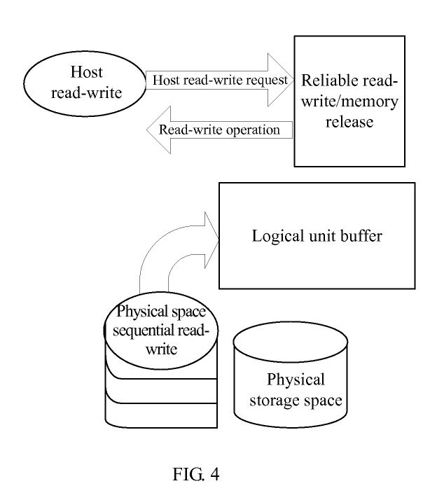

Referring to FIG. 4, it is a schematic diagram illustrating an embodiment for implementing reliable read-write, according to the present invention.

In the present embodiment, in the storage controller of the disk array, the logical unit supports normal read-write operation for the host. The logical unit implements reliable read-write for underlying modules of the sub-logical units. In addition, through adding memory release operation, reliable read-write serialization and prevention of memory overflow may be realized.

In summary, the network storage device and data read-write control method according to embodiments of the present invention realize enlargement of valid storage capacity of a single logical unit. For example, valid physical storage capacity over 1PB may be supported. For high-definition film-making and mass data computation, including medium-range weather forecast, new drug screening and high-energy physics calculation, a 1PB access capability to block data and unstructured data is provided. For existing logical unit access technologies, high performance capacity extension and large scale seamless capacity expansion may be realized.

Any suitable programming language can be used to implement the routines of embodiments of the present invention, including C, C++, Java, assembly language, etc. Different programming techniques can be employed, such as procedural or object oriented. The routines can execute on a single processing device or multiple processors. Although the steps, operations, or computations may be presented in a specific order, this order may be changed in different embodiments. In some embodiments, multiple steps, shown as sequential in this specification, can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

The above are only exemplary embodiments of the present invention and are not for limiting the scope of the invention. Any modifications, equivalent replacements and improvements within the spirit and principle of the present invention should be contained in the scope of the present invention.

What is claimed is:

1. A network storage device comprising a physical storage medium, further comprising:
a storage controller, configured to map the physical storage medium to sub-logical units and map the sub-logical units to logical units, so as to implement data storing, reading, and writing, wherein the sub-logical units are identified by sub-logical unit numbers and the logical units are identified by logical unit numbers.

2. The network storage device according to claim 1, wherein the storage controller comprises:
a storage unit, configured to store a mapping relationship between the sub-logical units and the physical storage medium and a mapping relationship between the sub-logical units and the logical units; and
a read-write control unit, configured to control data storing, reading, and writing, according to the mapping relationship between the sub-logical units and the physical storage medium, and the mapping relationship between the sub-logical units and the logical units.

3. The network storage device according to claim 2, wherein the read-write control unit implements data storing, reading, and writing in a reliable read-write manner.

4. The network storage device according to claim 2, wherein the read-write control unit controls data reading and writing in the logical units, according to a preset order.

5. The network storage device according to claim 2, wherein the read-write control unit implements data reading and writing, according to the start position identification of data blocks stored in each of the sub-logical units.

6. The network storage device according to claim 2, wherein a linked list is employed for the mapping relationship between the sub-logical units and the physical storage medium, and a one-to-one mapping relationship is employed for the mapping relationship between the sub-logical units and the logical units.

7. A data read-write control method, comprising:
acquiring a mapping relationship between a physical storage medium and sub-logical units, and a mapping relationship between the sub-logical units and logical units; and
controlling data reading and writing, according to the mapping relationship between the physical storage medium and the sub-logical units, and the mapping relationship between the sub-logical units and the logical units.

8. The data read-write control method according to claim 7, wherein data reading and writing is implemented in a reliable read-write manner.

9. The data read-write control method according to claim 7, wherein data reading and writing in the sub-logical units is implemented, according to a preset order.

10. The data read-write control method according to claim 7, wherein data reading and writing is implemented, according to the start position identification of data blocks stored in each of the sub-logical units.

11. The data read-write control method according to claim 7, wherein a linked list is employed for the mapping relationship between the sub-logical units and the physical storage medium, and a one-to-one mapping relationship is employed for the mapping relationship between the sub-logical units and the logical units.

12. A computer readable medium including code for acquiring a mapping relationship between a physical storage medium and sub-logical units and a mapping relationship between the sub-logical units and logical units; and
controlling data reading and writing, according to the mapping relationship between the physical storage medium and the sub-logical units, and the mapping relationship between the sub-logical units and the logical units.
